(19) United States
(12) Patent Application Publication
(10) Pub. No.: US 2009/0252542 A1
(43) Pub. Date: Oct. 8, 2009

(54) Image Fixing System With Improved Lubrication

(76) Inventors: Gregory Daniel Creteau, Winchester, NY (US); James Douglas Gilmore, Lexington, KY (US); Kathryn D. Mullins, Lexington, KY (US); Gillian Jane Ross, Lexington, NY (US); Jennifer Ann Wininger, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/062,742

(22) Filed: Apr. 4, 2008

(51) Int. Cl. G03G 15/20

(52) U.S. Cl. 399/329

(57) ABSTRACT

Disclosed is an image fixing system for use in an image forming system. The image fixing system of the present invention includes a heated member and a pressure member. Further disclosed is a lubricant for use in the image fixing system. The lubricant includes a fluorinated oil. Further, the lubricant includes less than or equal to about 25 percent by weight of a polytetrafluoroethylene filler.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Invention

The present invention relates generally to an image fixing system for use in an image forming system, and more specifically, to a lubricant employed in the image fixing system for improving wear properties and thereby enhancing effective lifetime of the image fixing system.

2. Description of the Related Art

In an image forming system, such as an electronic image forming system, an image fixing system is specifically employed to fix unfused toner images on an image-receiving medium for generating printed or fused toner images thereon. Suitable examples of the electronic image forming system include printers, copying machines, and the like. Suitable examples of the image-receiving medium include, but are not limited to, textiles substrates, non-woven substrates, canvas substrates, and cellulose substrates.

In general, the image fixing system includes a heated member. The heated member may include a heating element for generating heat required to melt the unfused toner images for fixing the same on to the image-receiving medium. Subsequently, the molten unfused toner images may be fused to form printed images on the image-receiving medium. Further, the heated member may include a fixing belt that is capable of rotating around the heating element. More specifically, the fixing belt is capable of sliding through a surface of the heating element.

The image fixing system further includes a pressure member abuttingly coupled to the heated member to form a nip therebetween. The pressure member may be a pressure roller that is capable of rotating in a specific direction.

During a typical image fixing process, the pressure member is capable of applying pressure against the fixing belt, thereby rotating the fixing belt in a direction which is opposite to the direction of rotation of the pressure member. Thereafter, when the image-receiving medium carrying the unfused toner image is received at the nip, the heating element generates heat for melting the unfused toner images. Further, rotation of the fixing belt as caused by the rotation of the pressure member enables the image-receiving medium to move through the nip of the image fixing system.

However, in such an image fixing process, a frictional resistance between the rotating fixing belt and the heating element may develop. Further, the frictional resistance so developed may gradually increase over a period. To circumvent the aforementioned drawback, lubricants are employed in between the fixing belt and the heating element. Lubricants provide an adequate lubrication in between the fixing belt and the heating element to reduce force required to rotate the fixing belt. Consequently, the lubricants provide an improved slideability to the fixing belt to rotate around the heating element. The moment of a force required to rotate the fixing belt may hereinafter interchangeably be referred to as “torque.”

In general, a lubricant employed in an image fixing system may include base oil and filler as essential components. The fillers are included in the lubricant to thicken the base oil into a paste or grease, thereby imparting a viscous characteristic to the lubricant. A suitable example of the base oil may be a fluorinated oil. Suitable examples of fillers may include, but are not limited to, polytetrafluoroethylene (PTFE) fillers.

However, it has always been challenging to optimize the viscosity of conventional lubricants for withstanding extreme temperatures that are typically attained in the image fixing system. Such extreme temperatures may include cold and low standby temperatures attained during an idle state of the image fixing system, and warm-up temperatures attained prior to an operative state of the image fixing system.

For example, a conventional lubricant having a low viscosity flows outwards from the fixing belt at an area of the nip. Due to such an outward flow, it becomes difficult to retain the conventional lubricant in between the heating element and the fixing belt for subsequent image fixing processes. Alternately, a conventional lubricant having an extremely high viscosity increases the torque required to rotate the fixing belt. Such an increased torque may gradually affect or deteriorate the slideability of the fixing belt, which in turn contributes to a significant damage of the fixing belt. Therefore, it is desirable to employ a lubricant having a sufficiently high viscosity for withstanding the extreme temperatures that are typically attained in the image fixing system.

Additionally, conventional lubricants have exhibited a tendency to separate into two phases, an oil phase and a solid phase, when subjected to high temperatures. Consequently, after a prolonged use, the lubricity of the conventional lubricants decreases as the base oil is lost from the nip area. The base oil loss or phase separation may occur due to a catalyzed reaction of the essential components of the conventional lubricants with chemical constituents of the heated member and the fixing belt. Suitable examples of such chemical constituents that are used for manufacturing the heated member and the fixing belt, may include, but are not limited to, metal, and metal oxide constituents.

Accordingly, there is a need for a lubricant to be used in an image fixing system for improving wear properties of the image fixing system, thereby enhancing its effective lifetime. Further, there is a need for a lubricant that may exhibit minimal degradation, and is capable of enduring extreme temperatures as attained in the image fixing system.

### SUMMARY OF THE INVENTION

In view of the foregoing disadvantages inherent in the prior art, the general purpose of the present invention is to provide a lubricant for use in an image fixing system, to include all the advantages of the prior art, and to overcome the drawbacks inherent therein.

In one aspect, the present invention provides an image fixing system including a heated member. The heated member includes a heating element, and a fixing belt enclosing the heating element. The fixing belt is capable of rotating around the heating element. Further, the image fixing system includes a pressure member abuttingly coupled to the heated member to form a nip therebetween. The nip is capable of receiving an image-receiving medium carrying unfused toner images thereon. Further, the pressure member is capable of pressing the image-receiving medium against the fixing belt. Furthermore, the image fixing system includes a lubricant that may be disposed on a surface of the heating element facing the fixing belt. The lubricant includes a fluorinated oil. Further, the lubricant includes less than or equal to about 25 percent by weight of a polytetrafluoroethylene filler.

In another aspect, the present invention provides a lubricant for use in an image fixing system. The lubricant includes a fluorinated oil. Further, the lubricant includes less than or equal to about 25 percent by weight of a polytetrafluoroethylene filler.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic depiction of components of an image fixing system according to an exemplary embodiment of the present invention;

FIG. 2 is a schematic depiction of a side view of a fixing belt according to an exemplary embodiment of the present invention;

FIG. 3 shows a graph depicting a comparison of torque values attained in an image fixing system using greases that include branched oil and greases that include linear oil;

FIG. 4 shows a graph depicting a comparison of torque values attained in the image fixing system, at a temperature of about 100° C., using greases that include a linear oil, and different fillers with varying weight percentages thereof;

FIG. 5 shows a graph depicting a comparison of torque values attained in the image fixing system, at temperatures of about 250° C. and 300° C., using greases that include a linear oil, and different fillers with varying weight percentages thereof; and

FIG. 6 shows a graph depicting values for mean coefficient of friction for greases that include preferred oil and varying weight percentages of polytetrafluoroethylene (PTFE) filler.

### DETAILED DESCRIPTION

It is to be understood that various omissions and substitutions of equivalents are contemplated as circumstances may suggest or render expedient, but these are intended to cover the application or implementation without departing from the spirit or scope of the claims of the present invention. It is to be understood that the present invention is not limited in its application to the details of components set forth in the following description. The present invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the terms “a” and “an” herein do not denote a limitation of quantity, but rather denote the presence of at least one of the referenced item. Unless limited otherwise, the terms “coupled,” and “mounted,” and variations thereof herein are used broadly and encompass direct and indirect couplings, and mountings. Furthermore, the use of “coupled” and variations thereof herein does not denote a limitation to the arrangement of two components.

As used herein, the term “lubricant” refers to a substance or a material that may be introduced between two or more surfaces for reducing friction and wear between the surfaces. Further, the lubricant may be in the form of a liquid or a semi-liquid.

As used herein, the term “viscosity” refers to an internal property of a fluid that represents the fluid's resistance to flow. The term may be applicable to fluids that include liquids and semi-liquids.

As used herein, the term “abuttingly coupled” refers to a coupling between two components placed adjacent to each other such that each component is capable of transmitting its motion to the other component.

As used herein, the term “warm-up time” refers to a time required by a heated member of an image fixing system to attain a predetermined temperature prior to an image fixing process. More specifically, the warm-up time refers to a time required to heat a surface of the heated member to a predetermined temperature that is required for fixing unfused toner images on an image-receiving medium. Therefore, it should be understood that the heated member needs to maintain a specific temperature even during a standby period to allow a quick recovery from a standby or idle state to a normal operative state.

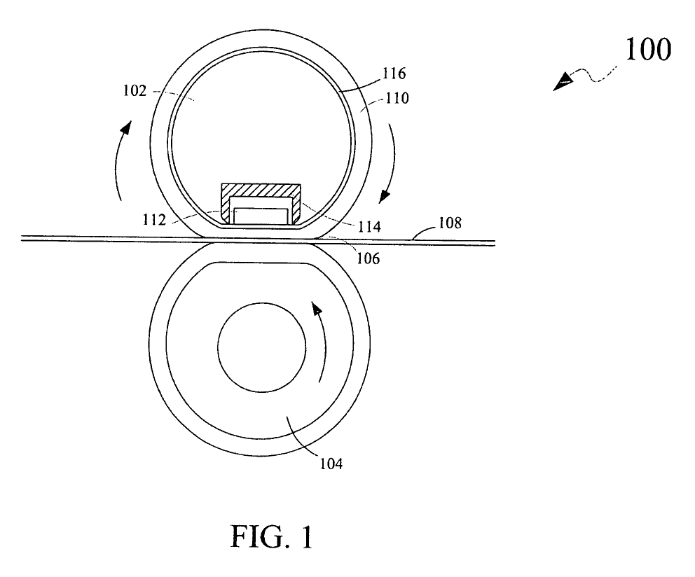

The present invention provides an image fixing system that may be employed in an image forming system such as an inkjet printer or copier, an electrographic printer or copier, and a thermal transfer printer or copier. More specifically, the present invention provides a suitable lubricant for use in the image fixing system. The lubricant of the present invention assists in improving wear properties of components of the image fixing system, thereby increasing effective lifetime of the image fixing system. The image fixing system employing the lubricant of the present invention is explained in detail in conjunction with FIG. 1.

FIG. 1 is a schematic depiction of components of an image fixing system 100 according to an exemplary embodiment of the present invention. As shown in FIG. 1, image fixing system 100 includes a heated member 102 and a pressure member 104 abuttingly coupled to heated member 102 to form a nip 106 therebetween. Nip 106 is capable of receiving an image-receiving medium 108 carrying unfused toner images (not shown) thereon. Therefore, nip 106 is capable of placing image-receiving medium 108 in proximity to heated member 102.

Heated member 102 provides heat for fixing unfused toner images on to image-receiving medium 108. The heat enables fusing of particles of the unfused toner images to form a printed image on image-receiving medium 108. For the purpose of this description, heated member 102 includes a fixing belt 110 enclosing a heating element 112 that is capable of generating heat. Further, fixing belt 110 is capable of rotating around heating element 112. More specifically, fixing belt 110 is capable of sliding along a surface (not shown) of heating element 112 that is facing fixing belt 110. Further, to prevent any electrical contact of heating element 112 with fixing belt 110, the surface of heating element 112 that faces fixing belt 110 may include a glass coating (not shown) thereon. Suitable examples of heating element 112 may include, but are not limited to, a nichrome wire, a heat lamp, and a ceramic heating element.

Without departing from the scope of the present invention, heating element 112 is mounted in a housing 114 that may be supported by a metal frame. However, it should be apparent to a person skilled in the art that housing 114 may also be enclosed within fixing belt 110.

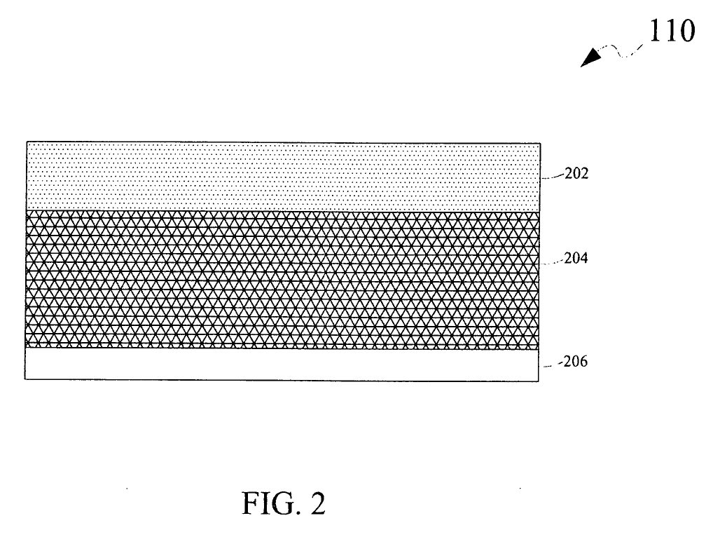

Fixing belt 110 employed in image fixing system 100 may be a seamless metallic belt. Further, fixing belt 110 may be made of a material of high heat resistance and strength. Without departing from the scope of the present invention, fixing belt 110 may be made of a metal or a polyimide. Fixing belt 110 is explained in detail in conjunction with FIG. 2.

FIG. 2 is a schematic depiction of a side view of fixing belt 110 according to an embodiment of the present invention. As shown, fixing belt 110 may include a base layer 202, and a compliant layer 204 coupled to base layer 202. Base layer 202 forms an innermost layer of fixing belt 110 such that base layer 202 faces heating element 112 of heated member 102. Base layer 202 may be a metallic layer made of stainless steel material. Further, base layer 202 may have a thickness ranging from about 30 to about 100 microns, and more specifically, from about 50 to about 100 microns.

Compliant layer 204 provides a suitable micro-compliance for fusing various colors of the unfused toner images. Further, the micro-compliance may be required to provide a good contact within unfused toner images and to fuse the unfused toner images exhibiting different toner pile heights. For the purpose of this description, compliant layer 204 may have high thermal conductivity ranging from about 0.5 to about 1.5 Watts per meter per degrees Kelvin (W/mK), and more specifically, ranging from about 0.8 W/mK to about 1.5 W/mK. Further, compliant layer 204 may have a thickness ranging from about 100 to about 600 microns. More specifically, compliant layer 204 may have a thickness of about 350 microns. Furthermore, compliant layer 204 may have a hardness ranging from about 5 to about 50 Shore A. In addition, compliant layer 204 may be made of a material that is thermally stable at temperatures greater than about 200° C. Therefore, an elastomeric material may be employed to prepare compliant layer 204. Silicone elastomer is a suitable elastomeric material that may be used to prepare compliant layer 204. In general, the silicone elastomeric material may include a thermally conductive filler to provide the requisite thermal conductivity.

Fixing belt 110 may further include a release layer 206 coupled to compliant layer 204 such that release layer 206 is the outermost layer of fixing belt 110 and is in contact with image-receiving medium 108 as shown in FIG. 1. Further, release layer 206 contacts a surface of image-receiving medium 108 carrying the unfused toner images that need to be fixed thereon, thereby preventing adherence of the unfused toner images to fixing belt 110. Release layer 206 may be made of a fluorocarbon material. Perfluoroalkoxy (PFA) is a suitable example of the fluorocarbon material for preparing release layer 206. Further, release layer may have a thickness ranging from about 10 to about 100 microns, and more specifically, from about 20 to about 50 microns.

Referring again to FIG. 1, it may be observed that fixing belt 110 may specifically be abuttingly coupled to pressure member 104 for the formation of nip 106. Pressure member 104 may be a pressure roller capable of rotating in one direction. Rotation of pressure member 104 enables a rotation of fixing belt 110 in an opposite direction. Such a coupled rotation of pressure member 104 and fixing belt 110 in opposite directions allows for movement of image-receiving medium 108 through nip 106. Further, pressure member 104 is capable of pressing a non-print-side of image-receiving medium 108 against fixing belt 110 in order to provide a close contact between image-receiving medium 108 and the unfused toner images present thereon. The non-print side of image-receiving medium 108 represents a surface opposite to the surface that carries the unfused toner images.

For the purpose of this description, pressure member 104 may include a metal core (not shown) forming a base of pressure member 104. A shaft may be a suitable metal core employed in pressure member 104. Further, pressure member 104 may include a compliant layer (not shown) adhering to metal core with the help of an adhesive. Compliant layer may be made of a thermally stable material such as silicone elastomer. Further, compliant layer may exhibit low thermal conductivity. The said property of compliant layer helps in preventing any heat loss from nip 106. More specifically, the said property of compliant layer prevents loss of heat to metal core, thereby allowing shorter warm-up times for image fixing system 100. Foamed silicone may be considered as a specific example of a material used for preparing compliant layer with low thermal conductivity.

Furthermore, pressure member 104 may include a release layer (not shown) that may be adhered to compliant layer such that compliant layer is sandwiched between metal core and release layer. Release layer may be made of perfluoroalkoxy (PFA) material. Further, release layer may have a thickness ranging from about 10 to about 100 microns, and more specifically, from about 20 to about 50 microns.

Image fixing system 100 further includes a lubricant for reducing a frictional resistance between fixing belt 110 and heating element 112. The lubricant of the present invention may be disposed in the form of a layer, on the surface (not shown) of heating element 112 that may face fixing belt 110. Subsequently, fixing belt 110 may be placed around heating element 112. Then, the lubricant may be distributed as a lubricant layer 116 to completely coat the inner surface of fixing belt 110 during normal use. In addition to reducing the frictional resistance, use of the lubricant reduces torque required by the pressure member 104 for rotating fixing belt 110 around heating element 112.

However, it should be apparent to a person skilled in the art that the lubricant may be disposed as a layer, such as lubricant layer 116, on a surface of fixing belt 110. More specifically, the lubricant layer may be disposed in a sufficient amount on an inner surface of fixing belt 110. Further, the lubricant layer disposed on the inner surface of fixing belt 110 may have a thickness ranging from about 0.1 microns to about 20 microns, and more specifically from about 5 microns to about 15 microns.

The lubricant of the present invention serves as a suitable and an effective lubricant for use in an image fixing system such as image fixing system 100 of FIG. 1. The lubricant includes a fluorinated oil as base oil. The fluorinated oil used may be a perfluoropolyether based oil. Such a perfluoropolyether based oil may either be a branched oil, a linear oil, or a combination thereof. A suitable example of the branched oil includes a polyhexafluoropropylene oxide based oil. A suitable example of the linear oil includes perfluoropolytrimethylene oxide based oil having a linear repeating unit consisting of three fully fluorinated methylene moieties followed by an oxygen atom.

Further, the lubricant of the present invention includes a filler that acts as a thickening agent. The filler is capable of increasing viscosity of the lubricant. Suitable examples of the filler include, but are not limited to, synthetic fluoropolymers such as polytetrafluoroethylene filler (PTFE), tungsten disulfide (WS2), boron nitride (BN) and combinations thereof. More specifically, the lubricant may include less than or equal to about 25 percent by weight of the PTFE filler. Even more specifically, the lubricant may include less than or equal to about 20 percent by weight of PTFE. Further, the PTFE filler may include particles having particle size of less than or equal to about 500 microns. More specifically, the PTFE filler may include spherically shaped particles. Without departing from the scope of the present invention, a lubricant that includes a filler may hereinafter interchangeably be referred to as “grease”.

Further, the lubricant may include additional components such as high temperature stabilizers, corrosion inhibitors, silica (Si), sodium nitrite (NaNO₂), and boron nitride (BN) to enhance effectiveness of the lubricant for withstanding extreme temperatures, eliminating probability of undergoing any degradation or corrosion, and providing additional lubricity to the image fixing system.

However, it should be obvious to a person skilled in the art that the efficiency of the lubricant of the present invention depends on the type of the filler, percent by weight of the filler, type of base oil, structure of the base oil, molecular weight of the base oil, viscosity of the base oil, and viscosity of the lubricant. The foregoing aspects of the present invention may be understood by referring to the following non-limiting example. However, one of ordinary skill in the art, and based on a reading of this detailed description, would recognize that, the specific example is intended to illustrate, not limit, the scope of the present invention.

### EXAMPLE

In the following example, different greases were investigated for use in between a fixing belt and a heating element of an image fixing system such as image fixing element 100 of FIG. 1. More specifically, the investigation was conducted for monitoring different compositions of greases based on three different criteria that included percentage oil separation at a temperature ranging from about 25° C. to about 250° C.; temperature at which the greases show a weight loss of about 2 percent on reacting with a metal oxide such as alumina; and torque required for rotating the fixing belt.

Table 1 shows specific properties of different greases that were investigated based on the aforementioned criteria. For the purpose of this description, perfluoropolytrimethylene oxide based oil, employed in some of the greases such as Formulations I-to-IV, may be referred to as “preferred oil” (PO). Further, in Table 1, “RT” represents percentage of oil separation at room temperature. Furthermore, the percentage weight loss for different greases was determined using Thermogravimetric Analysis (TGA) technique.

For a comparative analysis, Table 1 also shows properties of standard greases that include Krytox 206, Krytox 207, Krytox 226, Krytox 226 (commercially available standard greases from Dupont); L200 (commercially available standard grease from Daikin Industries, Ltd., of Japan); CL EXP-1A; CL Exp 1, CL Exp 2, CL Exp 3, CL Exp 4 (prepared from experimental greases obtained from Lubrication Technologies Inc.).

TABLE 1

| | | | | | | | | TGA |
|---|---|---|---|---|---|---|---|---|
| | | Percent by | | | | | | at 2% |
| | Filler | weight of | Oil | Oil Separation (%) | | | | loss on |
| Grease Name | Type | Filler (%) | Structure | RT | 100 | 200 | 250 | alumina |
| Krytox 206 | PTFE | 20 | Branched | — | — | 12.3 | 13.6 | 298 |
| Krytox 207 | PTFE | 17 | Branched | — | — | — | — | 308 |
| Krytox 226 | PTFE | 23 | Branched | — | — | — | — | 285 |
| | NaNO₂ | 2 | | | | | | |
| Krytox 227 | PTFE | 21 | Branched | — | — | 9.2 | 12.5 | 305 |
| | NaNO₂ | 2 | | | | | | |
| CL EXP-1A | PTFE | 21 | — | 0.09 | 7.7 | 13.5 | 16.2 | 336 |
| L200 | PTFE | 34 | Linear | 0.00 | 2.0 | 3.2 | 7.3 | 360 |
| Formulation I | PTFE | 17 | Linear | 2.53 | 8.0 | 12.3 | 18.1 | 360 |
| in PO | | | | | | | | |
| Formulation | PTFE | 17 | Linear | — | 6.5 | 12.0 | 15.2 | 360 |
| II in PO | BN | 5 | | | | | | |
| Formulation | PTFE | 17 | Linear | — | 3.2 | 8.4 | 11.1 | 360 |
| III in PO | BN | 10 | | | | | | |
| Formulation | PTFE | 17 | Linear | 0.66 | 4.2 | 8.5 | 10.2 | 360 |
| IV in PO | WS2 | 15 | | | | | | |
| Formulation V | WS2 | 30 | Linear | 5.10 | 10.0 | 13.5 | 16.7 | 360 |
| Formulation | WS2 | 45 | Linear | 0.00 | 2.0 | 5.3 | 6.2 | 360 |
| VI | | | | | | | | |
| Formulation | WS2 | 100 | — | — | — | — | — | 800 |
| VII (dry) | | | | | | | | |
| Formulation | PTFE | 17 | Linear | 1.12 | 7.1 | 12.8 | 15.1 | 360 |
| VIII | Silica | 0.5 | | | | | | |
| Formulation | PTFE | 17 | Linear | 1.22 | 5.9 | 11.2 | 12.8 | 360 |
| IX | Silica | 1 | | | | | | |
| CL Exp 1 | PTFE | 20 | Branched | 0.86 | 9.9 | 26.7 | 19.1 | 334 |
| CL Exp 2 | PTFE | 34 | Branched | — | 4.2 | — | 8.7 | 334 |
| CL Exp 3 | PTFE | 20 | Branched | — | 16.4 | — | 23.4 | 317 |
| | Corrosion | 5 | | | | | | |
| | Inhibitor | | | | | | | |
| CL Exp 4 | PTFE | 20 | Branched | — | 13.6 | — | 21.6 | 320 |
| | High | 3 | | | | | | |
| | Temp | | | | | | | |
| | Stabilizer | | | | | | | |

Referring to Table 1, it may be seen that most of the greases exhibiting a high percentage of filler were capable of exhibiting a low percentage for oil separation at a temperature ranging from about 25° C. to about 250° C. For improving wear properties of the image fixing system, it is desired to use a grease that exhibits a low percentage for oil separation at a temperature ranging from about 25° C. to about 250° C. In light of the foregoing, it should be understood that the greases that include linear fluorinated oil may be used as suitable greases in an image fixing system. Moreover, greases with a high viscosity may be retained in the image fixing system for a longer period.

From Table 1, it may also be seen that most of the greases were capable of exhibiting a percentage weight loss of equal to about 2% at a temperature greater than 300° C. More specifically, the greases that included PO were capable of exhibiting a percentage weight loss of about 2% at 360° C. For improving wear properties of the image fixing system, it is desired to use a grease that undergoes percentage weight loss of less than about 2% at a temperature greater than about 300° C. In light of the foregoing, it should be understood that greases that include PO may serve as suitable greases for use in the image fixing system. Moreover, such greases were capable of exhibiting a low percentage of oil separation at a temperature ranging from about 25° C. to about 250° C.

In addition, the above investigation also showed that PO is incapable of generating harmful emissions up to a temperature of about 300° C. Additionally, the perfluoropolytrimethylene oxide based oil is incapable of undergoing any degradation at temperatures below 260° C.

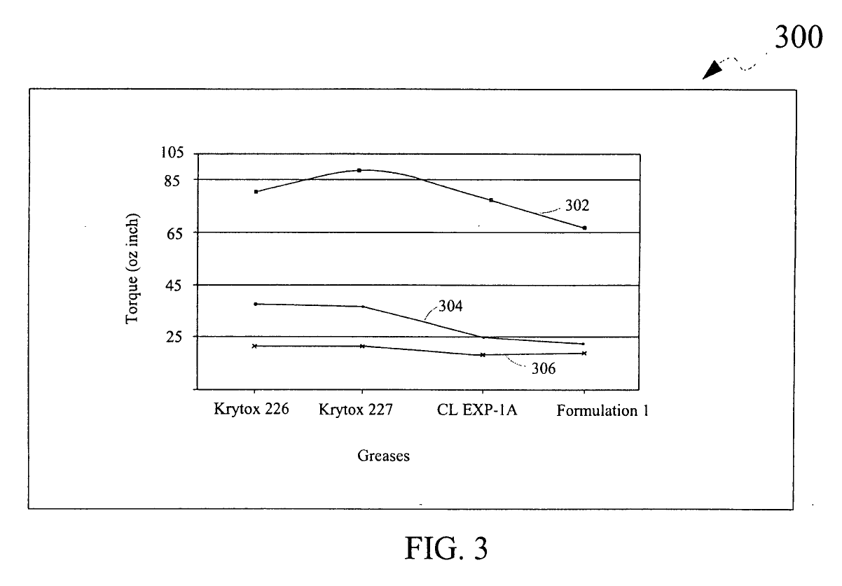

Referring now to FIGS. 3, 4, and 5, there are shown graphs that depict a comparison of torque values attained in the image fixing system using greases mentioned in Table 1.

FIG. 3 shows a graph 300 depicting a comparison of torque values attained in the image fixing system using greases that include branched oil and greases that include linear oil. More specifically, graph 300 depicts a comparison of torque values corresponding to four greases that included Krytox 226, Krytox 227, CL EXP-1A, and Formulation 1. Further, all the aforementioned greases under investigation included about 20 percent by weight of the filler. Graph 300 represents three different curves illustrated by curves 302, 304, and 306. Curve 302 depicts a plot of torque for all the aforementioned greases at a cold start temperature of about 100° C. Curve 304 depicts a plot of torque for all the aforementioned greases at an operating temperature of about 200° C. Curve 306 depicts a plot of torque for all the aforementioned greases at another operating temperature of about 250° C.

It may be seen that the greases including linear oil required a lower torque when compared with greases including branched oil. For example, it may be seen that at a temperature of about 200° C., Formulation 1 corresponds to a much lower torque when compared to Krytox 227.

In addition, the foregoing investigation aided in determining that oil having a low molecular weight was capable of exhibiting a higher percent by weight of oil loss at a temperature ranging from about 25° C. to about 250° C. Based on the conclusion that greases including linear oil require less torque in comparison with greases including branched oil, greases such as Formulation 1 may provide an improved lubrication for the image fixing system.

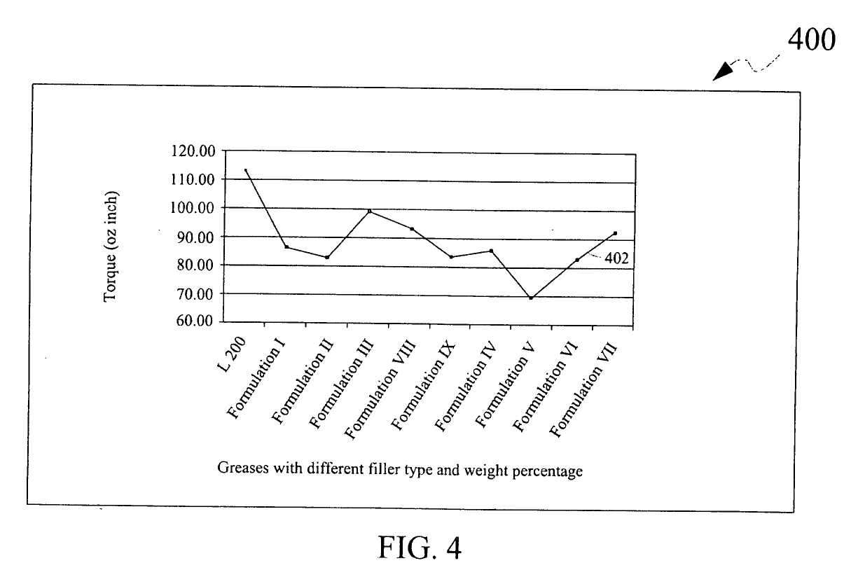

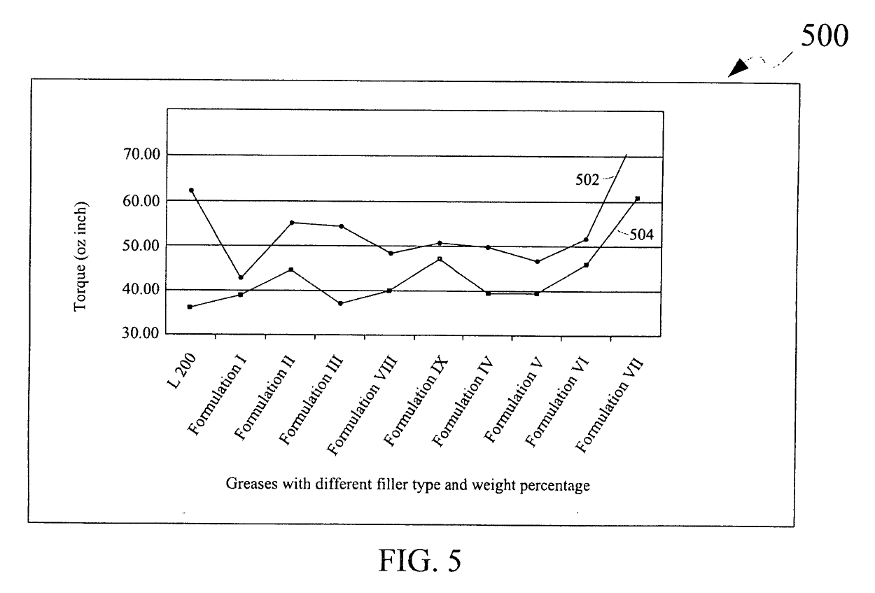

Referring now to FIG. 4 and FIG. 5, torque values were monitored for different greases including linear oil and different types of fillers with varying weight percentage thereof. More specifically, the torque values were monitored for ten different greases selected from the greases mentioned in Table 1. The ten different greases were L200, Formulation I, Formulation II, Formulation III, Formulation IV, Formulation V, Formulation VI, Formulation VII, Formulation VIII, and Formulation IX.

FIG. 4 shows a graph 400 depicting a comparison of torque values attained in the image fixing system, at a temperature of about 100° C., using greases that include linear oil, and different fillers with varying weight percentages thereof. More specifically, graph 400 represents a curve 402 that depicts different torque values attained at a temperature of about 100° C. For improving wear properties of the image fixing system, it is desirable to use greases that exhibit a torque less than about 90 oz inch at cold start temperature of about 100° C. Based on the foregoing, it may be seen that greases such as Formulations I, II, IV, V, VI, and IX exhibit torque values less than 90 oz inch. In addition, it was observed that greases including WS2 exhibited a torque less than about 90 oz inch, however, over a period of time, such greases provided unacceptable torque values. Hence, this indicated that greases such as Formulations I, II, and IX were the only greases that had exhibited acceptable torque values, and therefore the foregoing greases may be considered suitable for use in the image fixing system.

FIG. 5 shows a graph 500 depicting a comparison of torque values attained in the image fixing system, at temperatures of about 200° C. and about 250° C., using greases that include linear oil, and different fillers with varying weight percentages. More specifically, graph 500 represents two different curves illustrated by curves 502, and 504. Curve 502 depicts torque values at an operating temperature of about 200° C. Curve 504, depicts the torque values at another operating temperature of about 250° C. For improving wear properties of the image fixing system, it is desired to use greases that exhibit torque values much lower than about 90 oz inch at operating temperatures of about 200° C. and about 250° C. Based on the foregoing, it may be seen that Formulation I was the only grease that was capable of exhibiting low torque values at both the operating temperatures. Therefore, Formulation I that included 17% PTFE in PO may be considered as suitable grease for providing an improved lubricity in the image fixing system.

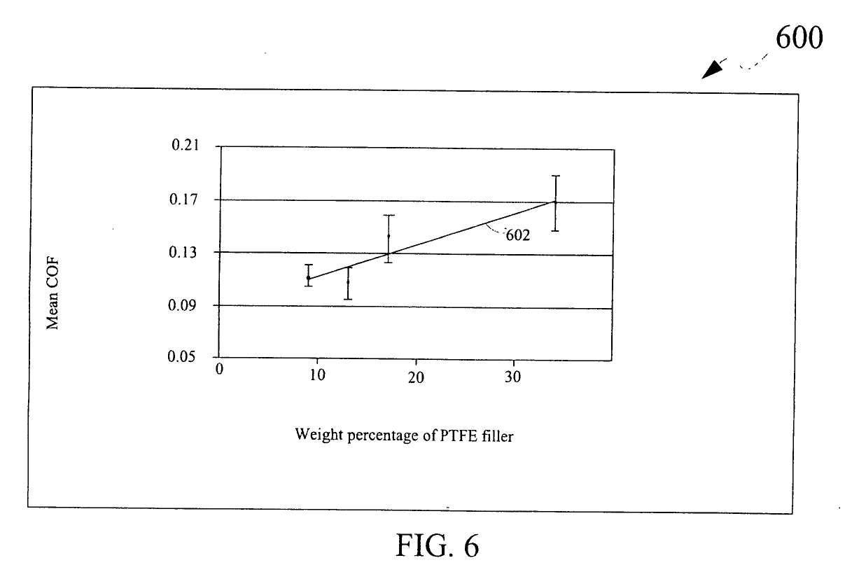

Without departing from the scope of the present invention, it should be understood that torque required to rotate a fixing belt of an image fixing system may be directly related to coefficient of friction (COF) corresponding to a particular grease. Accordingly, in addition to the above investigation, and to identify an optimum concentration of the PTFE filler to be used for preparing suitable greases, values of mean coefficient of friction for varying weight percentages of PTFE filler in PO were monitored. The values of mean COF were measured using a standard CSM tribometer from CSM Instruments. The foregoing study is explained in detail in conjunction with FIG. 6.

FIG. 6 shows a graph 600 depicting values for mean coefficient of friction for greases that include preferred oil and varying weight percentages of PTFE filler. More specifically, graph 600 depicts a plot of mean COF with different percentages of PTFE filler as represented by a line 602. For improving wear properties of the image fixing system, it is desired to use greases that exhibit low values of mean COF at a temperature ranging from about 25° C. to about 260° C. More specifically, it is desired to use greases that exhibit mean COF values below 0.15 at a temperature ranging from about 25° C. to about 250° C. Based on the foregoing and referring to FIG. 6, it may be seen that Formulation I was capable of exhibiting an acceptable mean COF value. Therefore, Formulation I that included 17% PTFE in PO is the most suitable grease for use in the image fixing system.

The lubricant, as described in the above aspects, is capable of withstanding temperatures that are below 260° C. without undergoing any degradation. Further, the lubricant exhibits sufficiently high viscosity and a low torque in the temperature range of about 25° C. to about 250° C. Furthermore, the lubricant is incapable of generating any harmful emissions up to a temperature of about 300° C.

The present invention provides an image fixing system with an improved lubrication. The image fixing system is used for fixing unfused toner images on an image-receiving medium to generate printed images thereon. The image fixing system of the present invention includes a heated member, a pressure member, and a lubricant. More specifically, the present invention provides an ideal lubricant for use in the image fixing system. Such a lubricant serves as an effective tool for enhancing effective lifetime of the image fixing system. The lubricant of the present invention includes base oil and a filler to provide sufficiently high viscosity to the lubricant. The use of the filler helps in retaining the lubricant in the image fixing system. However, it should be obvious to persons skilled in the art that the efficiency of the lubricant of the present invention depends on weight percentages of the filler and the filler's chemistry with the base oil. Nonetheless, the lubricant of the present invention includes an optimum concentration of the filler that is required to provide a good thermal contact between components of the image fixing system. In addition, the optimum concentration of the lubricant helps in preventing any oil separation from the components of the image fixing system.

The foregoing description of several embodiments of the present invention has been presented for purposes of illustration. It is not intended to be exhaustive or to limit the present invention to the precise forms disclosed, and obviously many modifications and variations are possible in light of the above teaching. It is intended that the scope of the present invention be defined by the claims appended hereto.

What is claimed is:

1. An image fixing system comprising:
a heated member comprising,
a heating element, and
a fixing belt enclosing the heating element, the fixing belt capable of rotating around the heating element;
a pressure member abuttingly coupled to the heated member to form a nip therebetween, the nip capable of receiving an image-receiving medium carrying unfused toner images, the pressure member capable of pressing the image-receiving medium against the fixing belt; and
a lubricant disposed on a surface of the heating element, the surface facing the fixing belt,
wherein the lubricant comprises a fluorinated oil and less than or equal to about 25 percent by weight of a polytetrafluoroethylene filler.

2. The image fixing system of claim 1 wherein the fixing belt is a seamless metallic belt.

3. The image fixing system of claim 1 wherein the fluorinated oil is a perfluoropolyether based oil.

4. The image fixing system of claim 1 wherein the fluorinated oil comprises perfluoropolytrimethylene oxide.

5. The image fixing system of claim 1 wherein the polytetrafluoroethylene filler comprises particles having particle size of less than or equal to about 500 microns.

6. The image fixing system of claim 1 wherein the polytetrafluoroethylene filler comprises spherically shaped particles.

7. The image fixing system of claim 1 wherein the weight percentage of the polytetrafluoroethylene filler is less than or equal to about 20 percent.

8. A lubricant for use in an image fixing system, the lubricant comprising:
a fluorinated oil; and
less than or equal to about 25 percent by weight of a polytetrafluoroethylene filler.

9. The lubricant of claim 8 wherein the fluorinated oil is a perfluoropolyether based oil.

10. The lubricant of claim 8 wherein the fluorinated oil comprises perfluoropolytrimethylene oxide.

11. The lubricant of claim 8 wherein the polytetrafluoroethylene filler comprises particles having particle size of less than or equal to about 500 microns.

12. The lubricant of claim 8 wherein the polytetrafluoroethylene filler comprises spherically shaped particles.

13. The lubricant of claim 8 wherein the weight percentage of the polytetrafluoroethylene filler is less than or equal to about 20 percent.
